(19) United States
(12) Patent Application Publication
(10) Pub. No.: US 2019/0205947 A1
(43) Pub. Date: Jul. 4, 2019

(54) System and method for profit-sharing with viewers of online advertising

(71) Applicant: Zhengping Zhang, Alexandria, VA (US)

(72) Inventor: Zhengping Zhang, Alexandria, VA (US)

(21) Appl. No.: 15/856,995

(22) Filed: Dec. 28, 2017

(51) Int. Cl. G06Q 30/02

(52) U.S. Cl. CPC G06Q 30/0277; G06Q 30/0247

(57) ABSTRACT

A system and method for profit sharing with viewers of online advertisements are disclosed. The system comprises a central control and a plurality of clients that are distributed to and installed on users' devices registered under viewers' accounts. The client, coordinating with ad blocking software or hardware, monitors online advertisements, controls the ad blocking, and communicates with the central control in sending publishers' or advertisers' information and following responses to allow or block the advertisements. Publishers or advertisers need to register with the system and pay for advertising on viewers' devices.

### FIELD OF THE INVENTION

The present invention relates generally to online advertising and more particularly to a system and method that enable online viewers to profit from online advertising.

### BACKGROUND OF THE INVENTION

The Internet has become the most widely used mediums for delivering advertisements and information. Online ad spaces are created by all kinds of websites and applications, such as social media or online games. The Internet, online, or web advertising involve a variety of parties, such as publishers who create, run, and maintain ad spaces, advertisers, goods or service providers, and viewers. The publishers, including app developers, attract the viewers to visit their websites or use their apps, where their ad spaces emerge. The advertisers pay for use of the ad spaces delivering their clients' advertisements to the viewers. The goods or service providers, the clients, pay for their advertisements delivered and have their products and services prompted and sold. Now online ad spaces have generated annual revenues close to 100 billion dollars in the United States alone. So far, the viewers, the largest populations involved in the marketing chain and whose personal information collected, used, and sold in the Internet advertising, have not been able to benefit financially from online advertising directly although their devices should be deemed part of the online ad spaces.

Advertisement blocking applications, so-called ad blockers, are developed to benefit the Internet users by protecting their privacy, blocking malvertising, and saving their bandwidth and time. Some ad blockers allow certain advertisers to pay for delivering their advertisements. However, the online ad viewers, have still been left out of sharing the advertising business profits.

With the trend that consumers have been spending more and more on personal smart devices, especially with the internet of things (IoT) in sight, the viewers are going to provide more ad spaces for the Internet advertising. Therefore, it would be desirable and fair to develop a system that enables the viewers to profit from the ever-growing Internet advertising and pressure online advertising industry to share their profits with the viewers.

Accordingly, these would be some objects and advantages of the present invention. Further objects and advantages would become apparent after consideration of the following detailed description and drawings.

### SUMMARY OF THE INVENTION

A profit sharing system for viewers of the advertisements through online ad spaces is basically a centralized ad blocking or filtering system, comprising a control server system and ‘a plurality of clients or stations that are distributed to and installed on users’ devices. The stations include ad blocking software or work with ad blocking hardware to prevent the devices from retrieving, receiving, displaying, playing, or engaging the advertisements. The control server system primarily comprises an ad-traffic control communicating with the stations, processing the data or information sent by the stations and collected or stored in the system, and governing other ad-traffic related servers or functions of the system; accounts users or viewers, recording the IDs of viewers' devices and associated stations and the demographic profiles of viewers and bookkeeping, viewers' money earned and spent; accounts for publishers or advertisers who are willing to pay for advertising through corresponding ad spaces to users' devices, registering their entities and profiles, recording their selection of predefined ad buying rules, and bookkeeping their funds and transactions; and a banking service transferring funds or credit from publishers' or advertisers' accounts to viewers' accounts according to the ad-traffic control's instructions based on actual ad-traffic and enabling viewers, publishers, or advertisers to check their account balances, to fund their accounts, or to pay for other online accesses or services. All account data is stored in databases of the system,

The stations of the central system, via web browsers, automatically inform the ad-traffic control of publishers' information, such as the website URLs or app identifiers, for instructions in whether to filter out coming online advertisements when the browsers request contents, open apps, or are fed with contents. The stations monitor, identify and, temporarily, block all advertisements or processes of retrieving them while waiting for instructions on further actions. Receiving the publishers' information, the ad-traffic control checks if the publishers have opened their publisher accounts. If the publishers maintain enough funds in their accounts, the ad-traffic control instructs the stations to lift their blocking and the banking service to make corresponding transactions-transferring the money or credit from the publishers' accounts, based on pre-selected buying rules, to viewers' accounts. If the publishers have no accounts or insufficient funds in the system, the ad-traffic control instructs the stations to maintain their blocking. The publishers with insufficient funds are notified and prompted to fund their accounts. Further, the stations identify the advertisers of the blocked advertisements and send the advertisers' information to the ad-traffic control for allowing at individual advertiser level. After finding those advertisers who have registered their accounts with sufficient funds in the system, the ad-traffic control instructs the stations to lift the blocking on those corresponding advertisements. A “whitelist” is compiled by the system automatically and used in the instructing process. If not receiving the instructions within a predetermined time, the stations proceed to allow or block advertisements basing on their local copies of the whitelist and use late coming instructions to update their whitelists, which are customized through actual local online uses or experiences.

Additional components, services, or tools of the profit-sharing system include blacklist/whitelist compiler, blacklist/whitelist updaters, blocking feedbackers, and blocking circumvention detectors. Except the compiler, all others are distributed with the stations and installed on viewers' devices. The compiler uses the ad-traffic data to compile automatically a blacklist for blocking listed publishers or advertisers and the account data of publishers and advertisers to compile automatically a whitelist for approving listed publishers or advertisers. Copies of the blacklist and whitelist are downloaded to viewers' devices, integrated into the stations, and updated by local updaters. The local copies of the blacklist may be consolidated into original blacklists of the stations. Local feedbackers monitor and record failures in either blocking or accepting advertisements and send recorded data to the central system in aiding the improvement on ad blocking algorithms. Local detectors automatically find and stop blocking circumvention or interruption software, if any, on viewers' devices.

The profit sharing system can be simplified for big publishers who have large numbers of registered members or users and have their own central systems controlling their apps or app clients. To secure their ad spaces for online advertising revenues, such publishers set up pay accounts for their members who agree not to install any software or hardware that block or interrupt their own ad spaces and they have their banking services ready for transferring money to these pay accounts. In the systems, the stations are replaced by the app clients having ad-blocking detectors that can find and stop any ad blocking software or hardware against advertising through the ad spaces of corresponding publishers. Furthermore, if the predetermined paying rules are based on memberships instead of members' online usages, even the ad-traffic control is not necessary the simplified systems.

The following detailed description together with the accompanying drawings will provide a better understanding of the nature and advantages, of the present invention.

### BRIEF DESCRIPTION OF DRAWINGS

FIG. 1 depicts a profit sharing system for viewers of online advertisements through website ad spaces according to an embodiment of the present invention.

FIG. 2 depicts a profit sharing system for viewers of digital advertisements through in-app ad spaces according to another embodiment of the present invention.

FIG. 3 depicts a profit sharing system for viewers of web advertisements through small publishers' ad spaces according to another embodiment of the present invention.

FIG. 4 depicts a profit sharing system, for viewers of Internet advertisements through large publishers' ad spaces according to another embodiment of the present invention.

### DETAILED DESCRIPTION—EMBODIMENTS

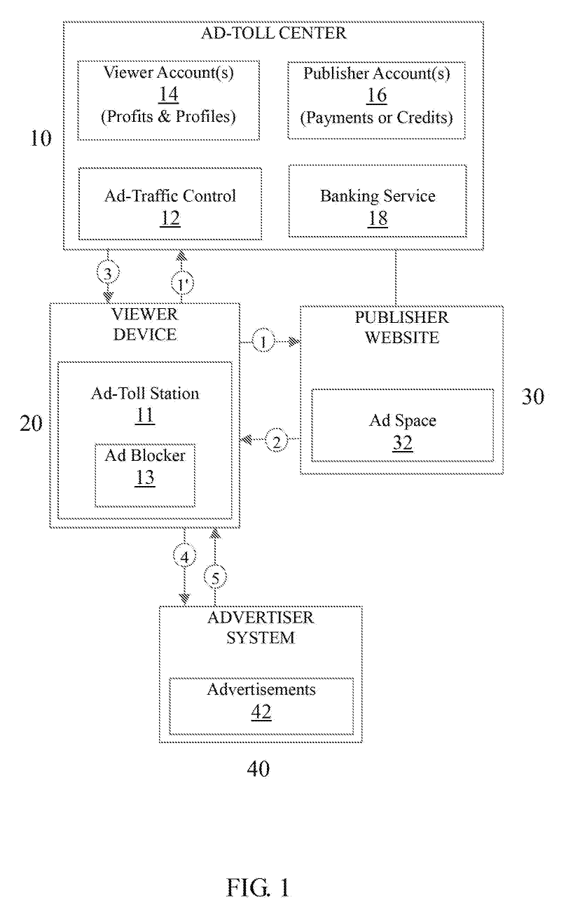

The depictions or drawings of FIGS. 1-4 present mainly key functions and/or components of the embodiments of the present invention and the conventional techniques, hardware, and software used for communicating, computing, processing, or data storing are well-known to a person skilled in the art and are intentionally ignored for clarity.

FIG. 1 depicts a profit sharing system for viewers of online advertisements through website ad spaces according to an embodiment of the present invention. Online advertising, also known as Internet advertising, web advertising, or digital advertising, is a form of marketing and advertising that leverages Internet technologies to deliver promotional marketing messages to consumers. The Internet technologies include emailing, social media, search engines, websites, web-based apps, Internet gaming, and mobile apps. A website ad space is a form of online ad spaces—the dimensions of electronic mediums allocated for hosting, serving and delivering advertisements through the Internet.

As illustrated in FIG. 1, the profit sharing system primarily comprises an ad-toll center 10, a viewer device 20, a publisher website 30, and an advertiser system 40. The term of “ad-toll” means a charge payable for allowing a particular advertisement or for permission to allow a particular advertisement to reach a viewer. The viewer device refers to a computer or mobile with a web browser used by an individual to view or play online contents. Publisher website 30, where the publisher refers to a content provider, maintains an ad space 32. The contents refer generally to any web site, text, document, file, media, app, service, or game that is digitally encoded and is deliverable across a communication network, such as the Internet. Advertiser system 40 includes the ad, server system of publishers, ad agencies, or ad exchanges and stores advertisements 42. The advertisement may be in a form of banner, pop-up, embedded, in-line, interstitial, or full page canvas advertisements that are presented when the viewer visits a page, navigates away from a page, closes a page, or is otherwise directed to a page or an advertisement. The advertisement may be provided as links, audio content, or visual content including text, images, and other multimedia content. Except center 10 and an ad-toll station 11 that is distributed to and installed on viewer device 20 and communicates with the former over the Internet, the rest are well known in the prior art of online advertising.

Ad-toll center 10 comprises an ad-traffic control 12, a viewer account 14, a publisher account 16, and a banking service 18, in addition to communicating via ad-traffic control 12 with ad-toll station 11 that controls an ad blocker 13. The term of “ad-traffic” means the data movement or flow of online advertisements. The ad blocker is software or hardware that can block or filter advertisements, which may be associated with a web browser extension or other software at the router level, as known to a person skilled in the art. Ad-toll station 11 is software and, when being installed on viewer device 20, establishes automatically a connection to register with center 10 and open its associated viewer account 14; so that its identity can be detected by and sent to ad-traffic control 12 in communication. The viewer account records its associated device identity or ID information, such as the media access control (MAC) address detected by center 10. Multiple devices may be registered in one viewer account; each account may have a viewer profile which data is provided voluntarily to earn more from targeted advertisements. Viewers can logon their own accounts, update their profiles, check their account balance, and transfer or spend their money online through banking service 18. The publishers who want the advertisements through their ad spaces 32 to reach the registered viewers need to open their publisher account 16, choose a predefined compensation rule or method for viewers, and fund or establish enough credits, through banking service 18. The techniques needed to build, operate, and maintain viewer account 14, publisher account 16, and banking service 18 are well known to a person skilled in the art.

According to the embodiment shown in FIG. 1, the profit sharing system for viewers may work as follows. At step (1), using a web browser of viewer device 20, a user sends a request for contents via the Internet to publisher website 30; at almost the same time—step (1′), ad-toll station 11 identifies the information of the publisher or website identifier in the request, such as its Uniform Resource Locator (URL), and sends ad-toll center 10 the information at ad-traffic control 12. At step (2), via its servers (not shown), website 30 responds by sending viewer device 20 the requested contents with the advertisements or information thereof associated with its ad space 32; ad blocker 13 puts the process of displaying or playing the advertisements or retrieving them on hold at least temporarily while ad-toll station 11 waits for an instruction from center 10 in whether to block. At step (3), ad-traffic control 12 sends ad-toll station 11 the instruction or signal after receiving and reviewing the publisher information. If the publisher has not opened publisher account 16 or does not have enough credits, the instruction is to block the advertisements; there are no further steps (4) and (5) for viewer device 20 to process. In contrast, if the publisher has enough credits in its own publisher account 16, the instruction is to allow the associated advertisements; and, basing on the compensation method chosen by the publisher, banking service 18 transfers a predetermined amount of fund or credit, a “toll”, from publisher account 16 to viewer account 14 that is associated with viewer device 20. At steps (4) and (5), if instructed to allow, ad-toll station 11 lifts the blocking posted by ad blocker 13 and viewer device 20 displays or plays allowed advertisements or retrieves them from advertisements 42 of advertiser system 40.

Additionally, during above process of step (3), ad-toll center 10 may provide registered publishers having sufficient funds with the profile info illation of viewers to maximize their profits from more targeted advertisements. Furthermore, the viewers may use their viewer account 14 to pay some publishers, who run pay-per-view websites where there are usually no ad-spaces 32, for accessing the restricted contents conveniently. After receiving the information of the publisher or host, probably along with a request to pay, from viewer device 20 at step (1′), ad-traffic control 12 instructs banking service 18 to check if viewer account 14 has enough credit against a pay-per-view rate determined by the publisher. If there is enough fund or credit, a predetermined amount is transferred from viewer account 14 to publisher account 16 and ad-traffic control 12 signals publisher website 30 to send requested contents at step (2); otherwise the ad-traffic control informs the viewer of no sufficient fund for requested access at step (3).

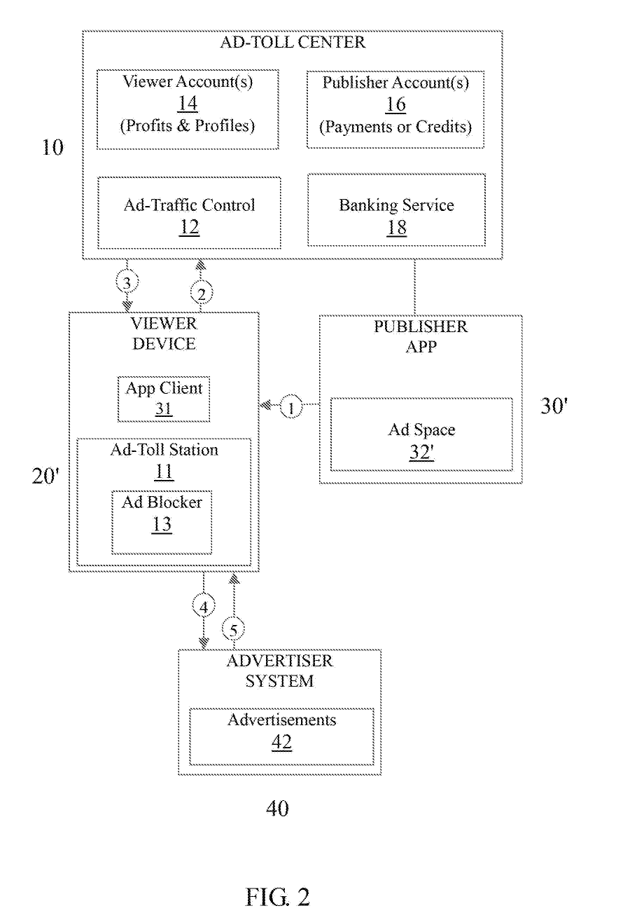

FIG. 2 depicts a profit sharing system for viewers of digital advertisements through in-app ad spaces according to another embodiment, of the present invention. This system includes the same ad-toll center 10 and ad-toll station 11 installed on a viewer device 20′. However, an ad space 32′ is embedded in a publisher app 30′, such as in Electronic Mail (email) or Web feed. Viewer device 20′ is slightly different from viewer device 20 because the former has an app client 31 installed, corresponding to publisher app 30′. As shown in FIG. 2, the profit sharing system for viewers works as follows. At step (1), publisher app 30′ sends or feeds viewer device 20′ its contents along with the advertisements or information thereof associated with its ad space 32′ via the Internet. App client 31 accepts the contents while ad blocker 13 puts retrieving, displaying, and playing the associated advertisements on hold. At step (2), ad-toll station 11 sends ad-toll center 10 the information of the app ID and waits for its instruction in whether to block or allow the advertisements. At step (3), ad-traffic control 12 sends ad-toll station 11 the instruction after reviewing the information against the records of the app or publisher. If the publisher or app provider does not have its own publisher account 16 or have enough credits in the account, the instruction is to block the advertisements. However, if the publisher or app provider has enough credits in its own publisher account 16, the instruction is to allow the advertisements; and banking service 18 transfers a predetermined amount of fund or credit from the publisher's account to the viewer's account 14. At steps (4) and (5), if the advertisements are allowed by center 10, ad blocker 13 releases its blocking so that app client 31 can retrieve, display, and/or play the associated advertisements.

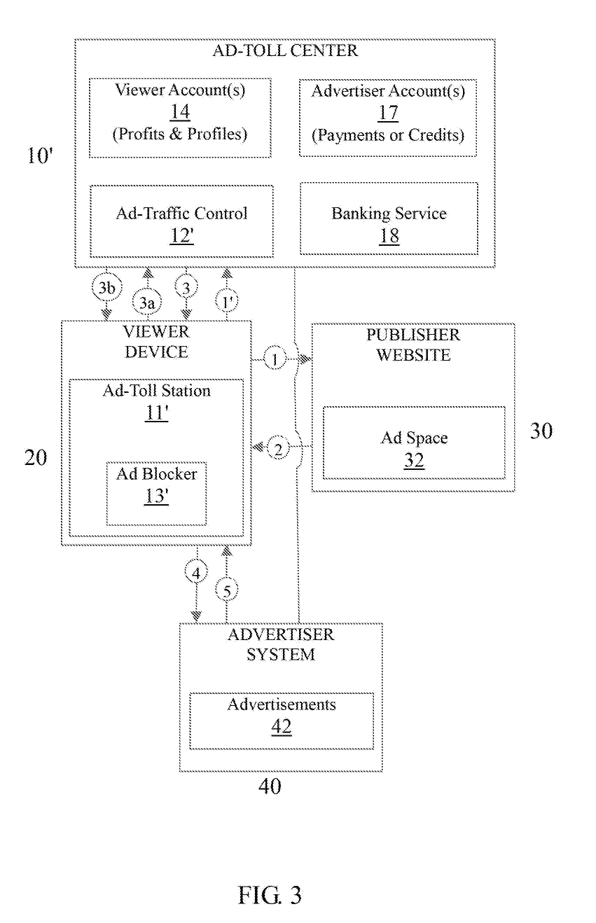

FIG. 3 depicts a profit sharing system for viewers of web advertisements through small publishers' ad spaces according to another embodiment of the present invention. This is almost the same as the embodiment illustrated in FIG. 1 except that the advertiser open an advertiser account 17 with an ad-toll center 10′ instead of a publisher; and center 10′ has alternatively an ad-traffic control 12′ communicating with an ad-toll station 11′ along with an ad blocker 13′, which all function slightly differently from their original ones shown in FIG. 1 to control ad-traffic at an advertiser level, instead of at a publisher level. Some publishers, especially those with small profits from selling or renting their ad spaces, may not want to share their profits with their viewers. However, the online traffic through their ad spaces may be attractive to some advertisers who are willing to pay for reaching registered viewers of center 10′.

The profit sharing system for viewers illustrated in FIG. 3 works also similarly as described previously for the embodiment shown in FIG. 1 but with extra steps of controlling ad traffic at individual advertiser level. At step (3a), after receiving an instruction from ad-traffic control 12′ to block the publisher at step (3), ad-toll station 11′ sends center 10′ the advertiser information obtained in step (2). At step (3b), ad-traffic control 12′ sends ad-toll station 11′ an instruction after receiving and reviewing the advertiser information. If the advertiser does not have its own account 17 or have enough credits in the account, the instruction is to block the advertisements of the advertiser. In contrast, if the advertiser has enough credits in its own account 17, the instruction is to allow the advertiser's advertisements; and banking service 18 transfers a predetermined, amount of fund or credit from the advertiser's account to the viewer's account 14. At steps (4) and (5), if instructed to allow, ad-toll station U releases the blocking posted by ad blacker 13′ and displays, plays, or retrieves the advertiser's advertisements.

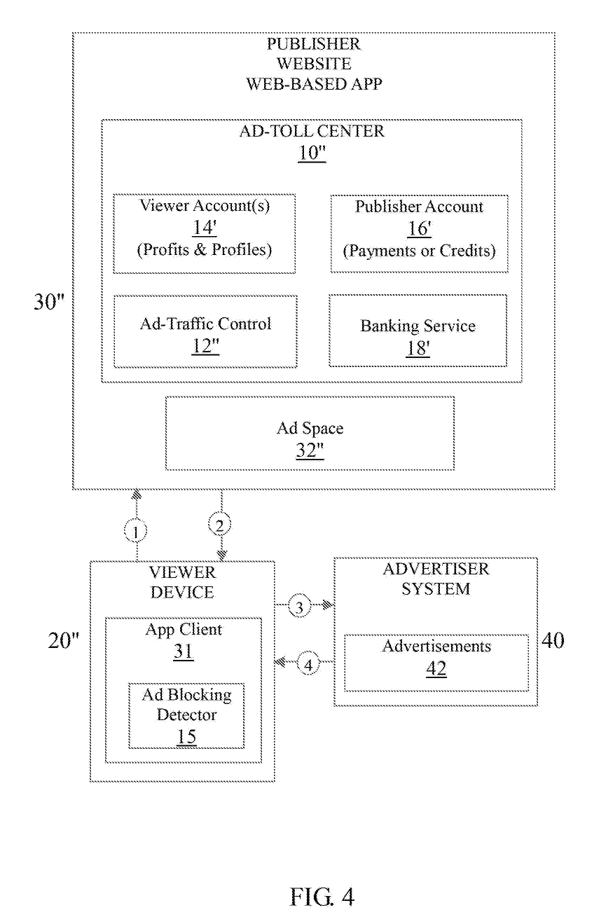

FIG. 4 depicts a profit sharing system, for viewers of Internet advertisements through large publishers' ad spaces according to another embodiment of the present invention. Publishers or companies that provide web-based apps and have large numbers of registered users may use such simplified profit sharing system to maintain or expand their market share. It similarly comprises an ad-toll center 10″, a viewer device 20″, a publisher website of a web-based app 30″, and an advertiser system 40. As illustrated in the system of publisher website 30″, however, ad-toll center 10″ is built and run by the same publisher who runs the publisher website and app system 30″. Ad-toll center 10″ also similarly comprises an ad-traffic control 12″, a viewer account 14′, a publisher account 16′, and a banking service 18′. Other than an app client 31 of web-based app 30″, no ad-toll station or ad blocker that could block the publisher's ad spaces 32″ is installed on viewer device 20″ as the viewer consents or agrees to a deal with the publisher. In return, the publisher creates viewer account 14′ for the viewer to get paid from receiving, viewing, or playing, the advertisements through publisher's ad space 32″. The viewer account is like a pay account to which banking service 18′ can transfer funds from publisher account 16′ basing on a predefined compensation rule and, therefore, is different from conventional membership accounts for publisher's website or app. Such a viewer account may be integrated to corresponding membership account as a new feature of the latter. To enforce the agreement with the viewer, an ad blocking detector 15 is either distributed with app client 31 as illustrated in FIG. 4 or integrated into ad-traffic control 12″ as an additional function thereof. The ad blocking detector can find, stop, or remove any ad blocking software or hardware against advertising through ad space 32″.

The profit sharing system for viewers illustrated in FIG. 4 works as follows. At step (1), app client 31 requests for some contents of publisher website or app 30″; at step (2), publisher website 30″ responds with requested contents and associated advertisements or the information thereof; at step (3), app client 31 retrieves the advertisements from advertiser system 40; and at step (4), viewer device 20″ receives, displays, and/or plays the advertisements. Thus, from the viewer's point of view, it is not different from regular web surfing or app playing. However, around the same time of step (2), another process undergoes in ad-toll center 10″. Aided by ad blocking detector 15, ad-traffic control 12″ monitors the transfer of advertisements to app client 31, calculates an amount that the viewer should be paid basing on predetermined rules that may depend on the contracts with advertisers, and orders banking service 18′ to make a transaction—transferring the amount of funds from publisher account 16′ to viewer account 14′.

Ad-toll center 10, 10′, or 10″ shown in FIGS. 1-4 only presents their main functions and/or components in above embodiments of the present invention and may include additional “utility” functions, features, or tools (not shown). General utility tools include a blacklist/whitelist compiler, a blacklist/whitelist updater, a blocking feedbacker, and a blocking circumvention detector. The updater, feedbacker, and detector are distributed with ad-toll station 11 or 11′ and installed on viewer device 20 or 20′. The compiler uses the data that ad-traffic control 12 or 12′ received at step (1′), (2), or (3a) to compile automatically a so-called blacklist, a basic access denial mechanism that denies those publishers or advertisers explicitly mentioned through email addresses, users, passwords, URLs, URL patterns, IP addresses, domain names, HTML patterns, and/or file hashes. The compiler also uses the data of publisher accounts 16 and advertiser accounts 17 to compile a so-called whitelist, the opposite of the blacklist, which mentions only publishers or advertisers that are allowed, accepted, approved, or recognized. Both blacklist and whitelist may be downloaded to viewer device 20 or 20′, and integrated into ad-toll station 11 or 11′, and used to aid processing the rejection or acceptation of advertisements. The blacklist may be consolidated into an original blacklist of ad blocker 13 or 13′. The whitelist can be used to decide the rejection or acceptation of advertisements if the instruction from ad-toll center 10 or 10′ at step (3) or (3b) is not received within a predetermined waiting time; and the late instructions may be taken automatically by the blacklist/whitelist updater to update the blacklist and whitelist. If the late instruction is to allow the advertisements that are blocked by the local whitelist, viewer device 20 or 20′ resumes steps (4) and (5), as illustrated in FIGS. 1-3. The blocking feedbacker monitors any failure in blocking advertisements and sends the information of unblocked ads to ad-toll center 10 or 10′ to aid revising or compiling blacklist and/or to improve the algorithms of ad blocker 13 or 13′. The blocking circumvention detector automatically finds and stops blocking circumvention or interruption software, if any, on viewer device 20 or 20′. The techniques for building these utility tools are known to a person skilled in the art.

### CONCLUSION, RAMIFICATIONS, AND SCOPE

The present invention accomplishes its stated objectives. A number of advantages of the present invention, from the description above, are evident:
It enables a large number of Internet population or users to share the profits of online advertising industry
It pressures and motivates publishers and advertisers to share their profits with online viewers.
It reduces unwanted advertising on the Internet by applying the financial pressure.
It consolidates Internet contents by reducing unwanted duplication of original contents for generating advertisement revenues.

While the above descriptions of the profit sharing system for viewers of online advertisements shown in FIGS. 1-4 contain certain specificity it should not be construed as limitations on the scope of the present invention, but exemplifications of the preferred embodiments thereof. Many other ramifications and variations are possible within the teachings of the various embodiments. Here are some examples of additional components, configurations, or applications: 1) a combination of the described embodiments; 2) deploying multiple ad-toll centers; 3) applying the ad-toll system to local networks; 4) applying the ad-toll system to an IP Multimedia Subsystem (IMS) network; 5) having less components or more utility features or tools, such as ad-traffic statistics and analysis; 6) sending the publisher and advertiser identity information simultaneously when possible, instead of consecutively; 7) integrating regular content filtering into the system; and 8) allowing advertisements to be subject to further filtering for inappropriate messages. Thus the scope of the present invention should be determined not by the examples given but by the appended claims and their legal equivalents.

1. A method for revenue-sharing with viewers of digital advertising, comprising the steps of: building a client-server system for an app, installing an app client onto a device of a user of said app, assigning a pay account to said user, integrating an ad detector with said app client, monitoring with said ad detector whether a digital advertisement is filtered at said device, sending a control server of said system the information about said digital advertisement if unfiltered, and transferring a predetermined amount of money or credit to said pay account by a banking server of said system for the unfiltered digital advertisement.

2. The method of claim 1 wherein said digital advertisement is provided or delivered by or through an ad server of said system.

3. The method of claim 6, further including the steps of: informing said publisher or provider that said digital advertisement was filtered and providing them with the information about how to open a payer account with said banking server.

4. The method of claim 2 wherein said ad detector automatically disables or removes the hardware or software that filters said digital advertisement.

5. The method of claim 1 wherein said ad detector is controlled by said control server to filter or allow said digital advertisement, further including the steps of: filtering with said ad detector said digital advertisement, identifying with said ad detector the publisher or provider of the contents that said digital advertisement is enclosed or associated with, sending said control server the identification information of said publisher or provider, and instructing said ad detector on whether to remain or remove said filtering.

6. The method of claim 5 wherein said step of instructing is to remain said filtering, further including the steps of: identifying the advertiser of said digital advertisement with said ad detector sending said control server the identification information of said advertiser and responding to a further instruction from said control server on whether to lift said filtering.

7. The method of claim 5, wherein said publisher or provider opens and funds a payer account with said banking sever and said predetermined amount of money or credit is withdrew from said payer account.

8. A centralized ad blocking system, comprising: an ad blocking application and a control center having an ad-traffic server; a plurality of copies of said ad blocking application being distributed to and installed on users' devices, connected to and controlled by said control center via computer networks, and executed to block digital advertisements while receiving digital contents at said users' devices, identifying the publishers of said digital contents and the advertisers of said digital advertisements, recording any failures in the blocking, and sending said ad traffic server the information of said publishers or advertisers or the data of said failures and said ad traffic server instructing said plurality on whether to remove or remain each blocking individually and promptly.

9. The system of claim 8, further including: a banking server of said control center, said banking server registering said users' devices, assigning each user a pay account, and transferring a predetermined amount of money or credit to the pay accounts related to the removal of said blocking at corresponding users' devices.

10. The system of claim 9 wherein those of said publishers or advertisers who are willing to pay for accessing said users' devices for advertising open their payer accounts through said banking server and said transferring are from corresponding payer accounts accordingly.

11. The system of claim 10, further including: a compiling server of said control center compiling a block whitelist based on the information of said payer accounts to list said those thereon and distributing said block whitelist to said users' devices, wherein said plurality remain or remove corresponding blocking basing on their local copies of said block whitelist if the instructions from said ad-traffic server are not received at corresponding users' devices within a predetermined time and update said local copies with said instructions when received if necessary.

12. The system of claim 8, further including: an updating server of said control center improving the algorithms or schemes of said ad blocking application with said data and updating said plurality at said users' devices with the improved version of said ad blocking application.

13. A profit-sharing method for viewers of digital advertisements, comprising: providing a central control system for an app, installing said app on a device of a user, said central control system communicating with said app through a communication network, registering said device, assigning a pay account to said user, instructing said app how to identify a digital advertisement, monitoring whether said digital advertisement is blocked at said device, and transferring a predetermined amount of money or credit to said pay account if said digital advertisement is not blocked, and said app identifying said digital advertisement with said how-to and notifying said central control system of the information about said digital advertisement.

14. The method of claim 13, wherein said digital advertisement is provided by or through said central control system.

15. (canceled)

16. The method of claim 14 wherein said central control system automatically disables or removes the hardware or software that can block said digital advertisement, further including: alerting said user for the disablement or removal.

17. The method of claim 13, further including: said app blocking said digital advertisement, recognizing the publisher or provider of the contents received at said device, sending said central control system the identification information of said publisher or provider, and lifting or remaining said blocking according to an instruction from said central control system.

18. The method of claim 17 wherein said instruction is for said remaining, further including: delivering a replacement advertisement to the designated position of said digital advertisement by or through said central control system transferring another predetermined amount of money or credit to said pay account for said replacement advertisement.

19. The method of claim 17, wherein said publisher or provider opens and funds a payer account; said instruction is for said lifting; and said predetermined amount of money or credit is withdrew from said payer account.

20. (canceled)

21. The method of claim 14, wherein said monitoring is through whether said central control system receives said information.

22. The method of claim 13, further including: said central control system instructing said app on whether to block said digital advertisement and said app reacting accordingly.
